(19) United States
(12) Patent Application Publication
(10) Pub. No.: US 2026/0344560 A1
(43) Pub. Date: Nov. 5, 2026

(54) Fertigation System

(71) Applicant: Nourish Labs Ltd., Surrey (CA)

(72) Inventors: Justin Jean Leonard Valmont, Abbotsford (CA); Blake Alexander Ponuick, Surrey (CA)

(73) Assignee: Nourish Labs Ltd., Surrey (CA)

(21) Appl. No.: 19/063,959

(22) Filed: Feb. 26, 2025

Related U.S. Application Data
(60) Provisional application No. 63/699,168, filed on Sep. 26, 2024.

(51) Int. Cl. A01C 23/00; A01C 23/04

(52) U.S. Cl. CPC A01C 23/007; A01C 23/042

(57) ABSTRACT

A system for preparation and delivery of a horticultural nutrient liquid, the system including a dosing apparatus, a mixing assembly, and a valve assembly The dosing apparatus includes dosage pumps configured to draw respective fertilizers from fertilizer containers and to inject the fertilizers into a piping apparatus, to generate a horticultural nutrient liquid. The mixing assembly is configured to receive the horticultural nutrient liquid and mix the horticultural nutrient liquid. The valve assembly is configured to control passage of the horticultural nutrient liquid from the mixing assembly to a second piping apparatus delivering the horticultural nutrient liquid to one or more plants. A control unit is optionally included to control operations of the dosing apparatus, the mixing assembly tank, and the valve assembly.

### CROSS-REFERENCES TO RELATED APPLICATIONS

The present application claims priority to U.S. Provisional Application Ser. No. 63/699,168 filed on Sep. 26, 2024, of which is hereby incorporated in their entirety.

### TECHNICAL FIELD

This invention relates to the field of agricultural technology, and more specifically, but not limited, to the formulation and delivery of nutrients to plants.

### BACKGROUND OF THE INVENTION

Our waters are being polluted at an alarming rate by agricultural effluent waste runoff. We're seeing water shortages around the world. Precision Irrigation can be a solution. Prior precision irrigation technologies would water plants with time-based irrigation events.

Plants can only absorb mineral ions when the fertilizer solution is within a specific pH range. The warmer the nutrient solution, the less Dissolved Oxygen (DO) it retains.

Fertigation system known in the general art use what's called “Inline delivery methods” which injects fertilizer, acid or base directly into an irrigation line, which immediately goes to the plants. Because the fertilizer is quickly delivered to the plants, the solution is not pH-balanced for several minutes. Expert cultivators rely on “micro-dosing”, which is a process of watering the crops with small amounts of water (60-500 ml) every 30-60 minutes. If it takes several minutes before pH-correctness is achieved by an inline delivery methods, then the plants receive a solution which is potentially hazardous and unabsorbable.

Some systems utilize “Day-storage tanks”. The Day Storage Tank is a large vessel (100-2000 gallons) which the inline fertigation systems fill up with nutrient solution. Since the volume is so large, it doesn't matter that the initial fertilizer solution is not within pH range because most of the volume added is. However, these tanks are quite large, and the fertilizer solution in the tanks can warm up from atmospheric temperatures and therefore may lose its dissolved oxygen quite quickly. In addition, the day-storage tank does not allow the cultivator to adjust pH or EC (electric conductivity) levels throughout the day, which is a condition necessary for optimizing the plant's substrates condition.

In addition, most competitors use “inline” systems, which injects concentrated fertilizers into an irrigation line which results in inconsistent nutrient mixtures, wastes water, and can result in chemical reactions or scaling in water lines from concentrated fertilizers mixing together.

### BRIEF SUMMARY OF INVENTION

An aim of the present invention is to produce consistent, homogenous, and pH-stable nutrient solutions prior to the delivery to the plants, and to deliver the nutrient solutions to the plans within a short time from production so that the dissolved oxygen in the nutrient solution is above a desired level.

Therefore, an aspect of some embodiments of the present invention relates to system for preparation and delivery of a horticultural nutrient liquid, the system comprising a first piping apparatus, a dosing apparatus, a mixing apparatus, a valve assembly, and a control unit. The first piping apparatus is configured to receive water from a water source. The dosing apparatus includes a plurality of dosage pumps which are configured to draw respective fertilizers from a plurality of fertilizer containers and to inject the respective fertilizers into the first piping apparatus, to generate a horticultural nutrient liquid. The mixing assembly is configured to receive the horticultural nutrient liquid exiting from the first piping apparatus after the water has been injected with one or more of the fertilizers, the mixing assembly being configured to mix the horticultural nutrient liquid so that the horticultural nutrient liquid is homogeneous. The valve assembly is configured to control passage of the horticultural nutrient liquid from the mixing assembly to a second piping apparatus configured to deliver the horticultural nutrient liquid from the mixing assembly to one or more plants. The control unit is configured to control operations of the dosing apparatus, the mixing assembly tank, and the valve assembly.

In a variant, the mixing assembly includes a mixing tank, a return pipe, a mixing pump, and a sensor. The return pipe exits the mixing tank and returns into the mixing tank. The mixing pump is configured to draw the horticultural nutrient liquid from the mixing tank into the return pipe. The sensor is configured to measure one or more parameters indicative of a homogeneousness of the horticultural nutrient liquid exiting the mixing tank and output sensor data. The valve assembly connects the return pipe to the second piping apparatus. The control unit is configured to process the sensor data to determine a level of the homogeneousness of the horticultural nutrient liquid.

In another variant, the mixing assembly comprises an acid pump and a base pump, the acid pump being configured to deliver acid from an acid reservoir into the mixing tank or the return pipe, and the base pump configured to deliver base from a base reservoir into the mixing tank or the return pipe. The mixing assembly comprises a pH sensor configured to measure a pH of the horticultural nutrient liquid in the mixing tank or the return pipe. The control unit is configured to control the acid pump and the base pump to bring the pH level of the horticultural nutrient liquid in the mixing assembly to a desired level.

In yet another variant, the system includes a plurality of mixing assemblies, wherein the first piping comprises a single first pipe opens at the plurality of mixing assemblies. The system comprises a plurality of entry valves controlling entry of the horticultural nutrient liquid into the plurality of mixing assemblies. The control unit is configured to control the entry valves to direct the horticultural nutrient liquid to one or more of the plurality of mixing assemblies.

In a further variant, the system includes the second piping, wherein the second piping includes at least one pipe and a drain valve. The at least one pipe having a plurality of emitters along a length of the pipe and a drain opening downstream of the emitters. The drain valve configured to open and close the drain opening. The control unit is configured to selectively open the drain valve to enable dumping of the horticultural nutrient liquid inside the second piping out of the drain opening.

In yet another variant, the system includes a water input apparatus configured to draw water from the water source into the first piping, wherein the control unit is configured to: receive input data comprising a number of plants in a grow area and an amount of the horticultural nutrient liquid each plant requires; process the input data to calculate a total volume of the horticultural nutrient liquid required for the grow area and a time period during which the total volume of horticultural nutrient liquid is dispensed to the grow area; receive data indicative of a recipe of the horticultural nutrient liquid, wherein the data indicative of the recipe comprises a proportion of each of the fertilizers in the horticultural nutrient liquid; process the total volume of the horticultural nutrient liquid and the data indicative of a recipe of the horticultural nutrient liquid, to calculate a total amount of each of the fertilizers to inject into the water; process the total volume of the horticultural nutrient and total amount of each of the fertilizers to calculated a desired amount of water; control the water input apparatus to draw the desired amount of water and control the dosing unit to inject the total amount of each of the fertilizers, to form the horticultural nutrient according to the recipe.

The control unit may be configured to control the dosing apparatus to set a delay between the injection of each fertilizer.

In yet a further variant, at least one of the dosing pumps the dosing apparatus is connectable to a cleaning agent reservoir and is configured to inject a cleaning agent into the first piping.

In a variant, at least one of the dosing pumps the dosing apparatus is connectable to a cleaning agent reservoir and is configured to inject a cleaning agent into the first piping. The mixing apparatus comprises a spray nozzle configured for receiving the cleaning agent and spraying the cleaning agent on interior sides of the mixing tank.

In a variant, the system comprises a channel leading from the return pipe to the spray channel and a valve configured to be controllably opened and closed for regulating passage of the cleaning agent from the return pipe into the spray nozzle.

In another variant, the control unit is configured to control a pressure at which the mixing pump pumps the horticultural nutrient.

In yet another variant, the control unit comprises a user interface utility configured to receive user instructions and a storage utility for storing the user instructions.

In a further variant, the control unit comprises a user interface utility configured to generate for display an interactive dashboard that provides information about an activity of the fertigation system.

In yet a further variant, the system includes at least one medium sensor measure one or more characteristics of a medium in which at least one of the one or more plants grows and to generate medium data. The control unit is configured to receive the medium data at a predetermined frequency and provide a representation of measurements of the one or more characteristic over time for display.

In a variant, the system includes at least one medium sensor configured measure one or more characteristics of a medium in which at least one of the one or more plants grows and to generate medium data. The control unit is configured to receive the medium data at a predetermined frequency and process the medium data to modify a predetermined recipe of horticultural nutrient liquids or generate a new recipe of the horticultural nutrient liquids to match a need of the at least one of the one or more plants based on the medium data.

In another variant, the system includes a water input apparatus configured to draw water from the water source into the first piping, wherein the control unit is configured to control an operation of the water input apparatus.

### BRIEF DESCRIPTION OF THE DRAWINGS

FIG. 1 is a block diagram illustrating a fertigation system according to some embodiments of the present invention;

FIG. 2 is a perspective drawing illustrating the dosing apparatus of the fertigation system of FIG. 1, according to some embodiments of the present invention;

FIG. 3 is a diagram illustrating an example of the dosing apparatus of FIG. 2, according to some embodiments of the present invention;

FIGS. 4 and 5 are diagrams illustrating fertigation systems with multiple mixing assemblies, according to some embodiments of the present invention;

FIGS. 6 and 7 illustrate an example of the mixing assembly of the fertigation system of FIG. 1, according to some embodiments of the present invention;

FIGS. 8-10 illustrate different phases of the operation of the mixing assembly, according to some embodiments of the present invention;

FIG. 11 illustrates to mixing assemblies in series, which enables the bypassing of the one mixing assembly, for filling a subsequent one, according to some embodiments of the present invention;

FIG. 12 illustrates an example of a second piping joined to the fertigation system of FIG. 1, according to some embodiments of the present invention;

FIG. 13 is a screenshot generated by a control utility of the present invention, showing “Batch-record” which includes serial numbers and quantities of all chemicals used to create a certain horticultural nutrient liquid, the pH, electric conductivity (EC), and temperature of the horticultural nutrient liquid, and the name of the user who instructed the system of the present invention to generate the horticultural nutrient liquid;

FIG. 14 is a screenshot generated by a control utility of the present invention, showing an interactive home screen dashboard that provides information about an activity of the fertigation system within a predetermined or chosen time period; and

FIGS. 15 and 16 illustrate an example of a control unit of the fertigation system of some embodiments of the present invention, housed in an IP-rated enclosure which is wall-mountable for ease of access;

FIG. 17 is a block diagram of the control unit, according to some embodiments of the present invention

FIG. 18 illustrates a fertigation system which is configured to receive data indicative of characteristics of the medium in which plants grow, according to some embodiments of the present invention; and

FIG. 19 illustrates a flowchart showing an example of a how the system of the present invention creates and dispenses a horticultural nutrient liquid, according to some embodiments of the present invention.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

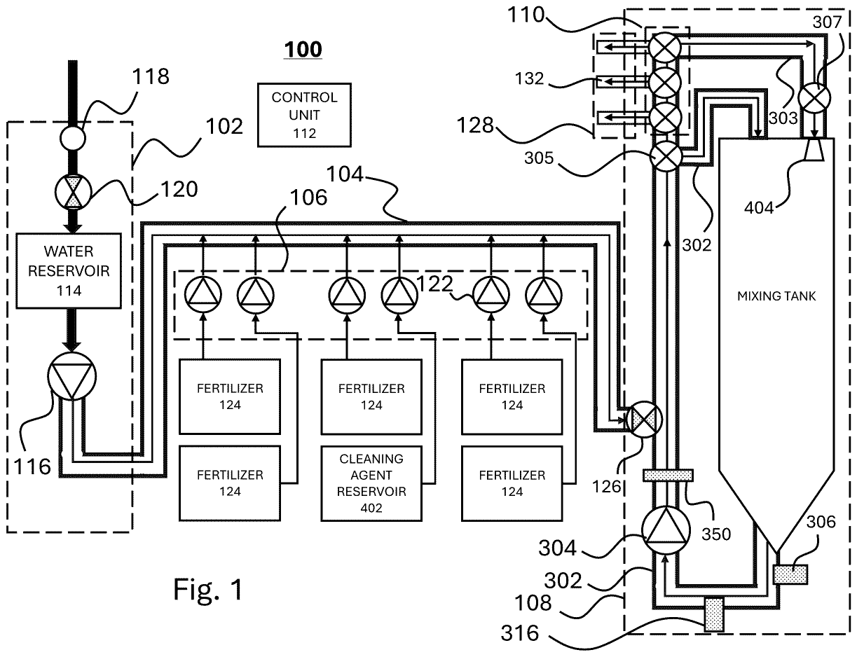

Referring now to the drawings, FIG. 1 is a block diagram illustrating a fertigation system 100, according to some embodiments of the present invention.

The fertigation system 100 includes a water input apparatus 102, a first piping apparatus 104, a dosing apparatus 106, a mixing assembly 108, a valve assembly 110, and a control unit 112, as seen in FIG. 1.

The water input apparatus 102 is configured to draw water from a water source. The water source may include city water, or condensate water, or water from a reservoir, such as lake or a river. The water input apparatus 102 may include a water pump 116 configured to pump water from the water source into the first piping apparatus 104. The operation of the water pump 104 may be controlled by the control unit 106, or by a pressure switch

The water input apparatus may include a water reservoir 114 configured to be filled by water from the water source, prior to being introduced into the first piping apparatus by the water pump 116. The water input apparatus 102 may also include a flow meter 118 and an input valve 120. The flow meter 118 measures the volume of water flowing from the source to the reservoir 114. The input valve 120 selectively stops water from the source to enter the reservoir (for example, when the reservoir is full or needs cleaning).

The first piping apparatus 104 is configured to guide water drawn by the water input apparatus. The first piping apparatus includes a pipe that receives water from the water pump 116, and guides the water via the dosing apparatus 106 and into the mixing assembly 118.

The dosing apparatus 106 includes a plurality of dosage pumps 122, each connectable to a respective fertilizer container 124, which contains a certain fertilizer. The fertilizer containers may be removable and interchangeable, so that any desired fertilizer can be connected to a dosage pump 122. The fertilizer containers 124 may be part of the dosing apparatus 106, or may be connectable of the dosing pumps 122. The dosing pumps 122 are configured to draw the respective fertilizers from the respective fertilizer containers 124 and to inject the respective fertilizers into the first piping apparatus 104, in order to generate a horticultural nutrient liquid. The dosing apparatus 106 may include any number of dosage pumps 122, such as two, three, six, eight, or more, for example. The operation of the dosing pumps 122 is controlled by the control unit 112, so the right fertilizers are injected into the water in the right quantities and flow rates.

The mixing assembly 108 is configured to receive the horticultural nutrient liquid exiting from the first piping apparatus 104 after the water has been injected with one or more of the fertilizers by the dosing apparatus 106, and is configured to mix the horticultural nutrient liquid so that the horticultural nutrient liquid is homogeneous. In some embodiments of the present invention, the mixing assembly 108 includes an entry valve 126, configured for selectively allowing the passage of the horticultural nutrient liquid from the first piping 104 into the mixing assembly 108.

The valve assembly 110 is configured to control passage of the horticultural nutrient liquid from the mixing assembly 108 to a second piping apparatus 128 configured to deliver the horticultural nutrient liquid from the mixing assembly 108 to one or more plants. The valve assembly may include one or more plurality of exit valves 130, and the second pipe apparatus may respective one or more second pipes 132. Each second pipe 132 is connected to a respective exit valve 130 and delivers the horticultural nutrient liquid to a respective location (or zone) for feeding respective plants. In FIG. 1, a non-limiting example shows that the valve assembly has four exit valves connected to four third pipes. However, the scope of present invention extends to having any number of valves connecting to any number of respective second pipes for delivering the horticultural nutrient liquid to any number of zones. It should be also noted that at least one of the second pipes may be a drain pipe that does not lead to any plant and is only used to drain the horticultural nutrient liquid from the mixing assembly 108 when the horticultural nutrient liquid is no longer needed. The valve assembly 110 is controlled by the control unit 112.

The control unit 112 is configured to: (i) control the water input 102 apparatus to draw a desired quantity of the water at a desired rate; (ii) control the dosing apparatus 106 to inject desired quantities of the fertilizers into the first piping apparatus 104 at a desired rate; (iii) control the mixing assembly 108 to mix the horticultural nutrient liquid until desired parameters of the horticultural nutrient liquid are satisfied; and (iv) control the valve assembly 110 to enable and disable passage of the horticultural nutrient liquid from the mixing assembly to the second piping apparatus 128.

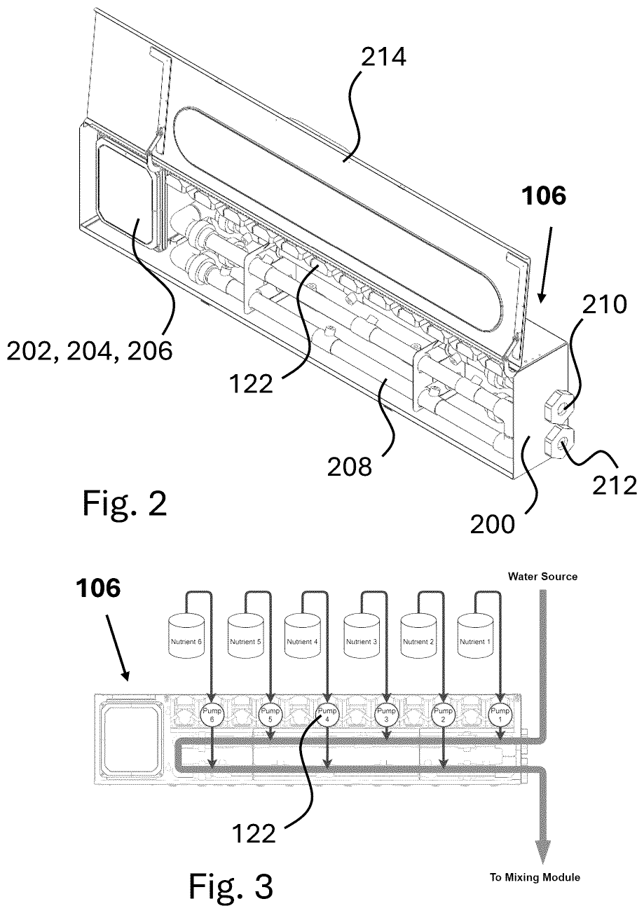

FIG. 2 is a perspective drawing illustrating the dosing apparatus 106 of the fertigation system of FIG. 1, according to some embodiments of the present invention. FIG. 3 is a diagram illustrating an example of the dosing apparatus 106 of FIG. 2, according to some embodiments of the present invention.

In some embodiments of the present invention, illustrated in FIGS. 2 and 3, the dosing apparatus 106 includes a unique, fertilizer dispensing panel which uses software (form the control unit) to sequence various chemicals/fertilizers at specific rates.

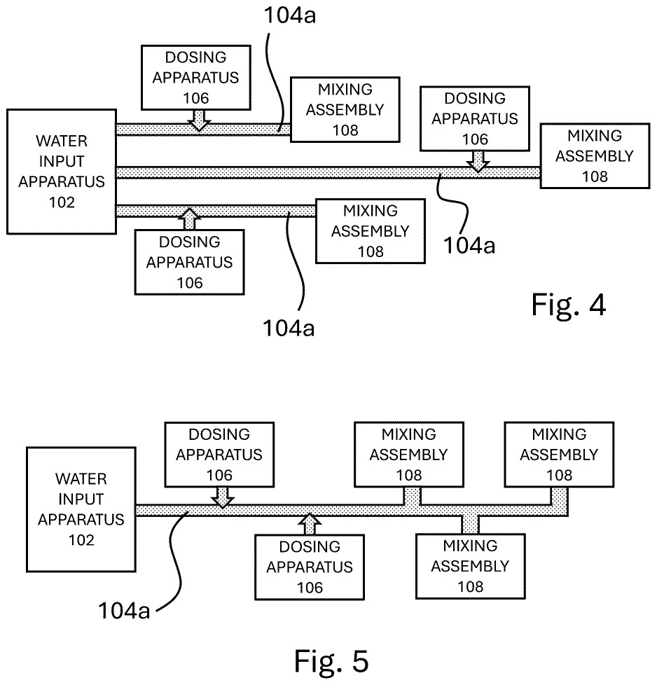

In a non-limiting example, one or more dosing apparatuses can meet the needs of a plurality of mixing assemblies. In one example, as shown in FIG. 4, a plurality of first pipes 104a is present in the first piping apparatus, each first pipe leading to a respective mixing assembly 108 and being fed by a respective dosing apparatus 106. In another example, a single first pipe 104a in the piping apparatus leads to a plurality of mixing assemblies 108 disposed in series, and one or more dosing apparatuses 106 are disposed along the single first pipe 104a. Entry valves in the mixing assemblies regulate the flow to specific mixing assemblies.

The dosing panel enclosure 200 is a self-contained unit which houses the following: a secondary control unit 202 in communication with the control unit or a communication unit 204 communicating with the control unit, a power supply 206, a plurality of (peristaltic) dosing pumps (for example, up to twelve), and a plumbing arrangement 208 having an entrance 210 and an exit 212 that feeds fresh water through the enclosure where fertilizer is injected. All components of the dosing apparatus may be housed in a wall-mountable stainless-steel enclosure 200. The entrance 210 and exit 212 may be part of the first piping apparatus or may be connected to the first piping apparatus. A door 214 (which may be a hinged door or a sliding door) closes the dosing panel enclosure 200.

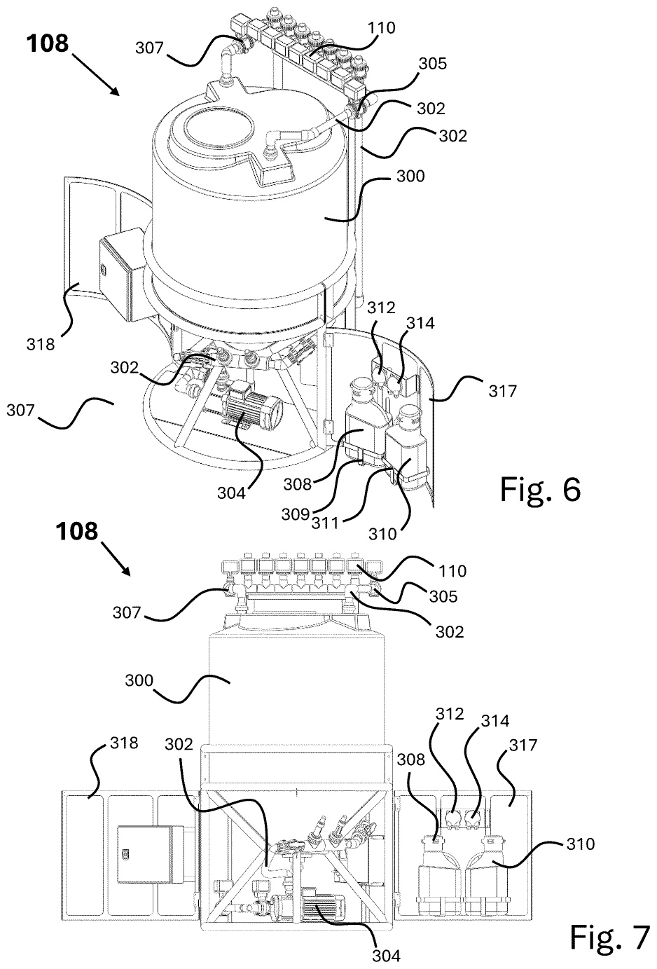

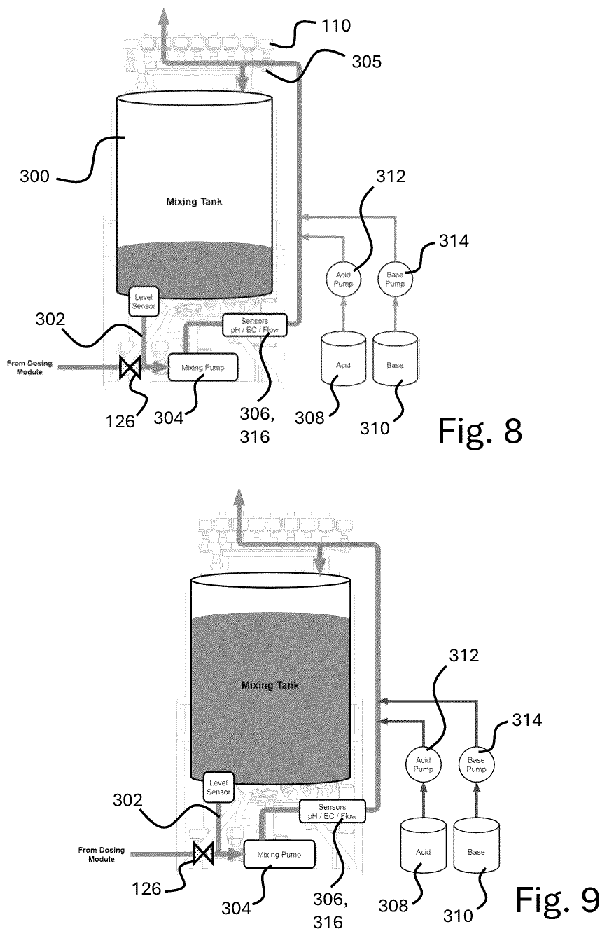

FIGS. 6 and 7 illustrate an example of the mixing assembly 108 of the fertigation system of FIG. 1, according to some embodiments of the present invention. FIGS. 8-10 illustrate different phases of the operation of the mixing assembly 108, according to some embodiments of the present invention.

The mixing assembly 108, as shown in FIGS. 6 and 7, has a unique process flow which allows the mixing assembly 108 to adjust the pH of the fertilizer solution. Each mixing assembly 108 receives the fertilizer solution from the dosing panel, pH-balances the solution, and dispenses the exact volume required to the crops, once the solution is homogeneous and pH-stable. This ensures that a desired amount of horticultural nutrient liquid is produced and quickly delivered to the plants, therefore ensuring high levels of dissolved oxygen.

Moreover, in the embodiment in which the fertigation system includes a plurality of mixing assemblies, each mixing assembly is able to contain and mix and regulate the pH of a respective horticultural nutrient liquid, independently from the others.

Referring to FIGS. 1, 6 and 7, the mixing assembly 108 may include a mixing tank 300 (for example, a vessel ranging from 30-1000 gallons), a return pipe 302, a mixing pump 304 (e.g. ¼ to 5 hp), and a homogeneousness sensor 306 device. The return pipe 302 receives horticultural nutrient liquid, guides the horticultural nutrient liquid around a loop formed by the mixing tank 300 and the return pipe 302, such that the horticultural nutrient liquid enters the mixing tank 300, exits the mixing tank via the return pipe 302, and is directed back into the mixing tank by the return pipe 302. The mixing pump 304 is configured to move the nutrient liquid in the loop formed by the mixing tank 300 and the return pipe 302. The motion around the closed loop mixes the horticultural nutrient liquid and therefore makes the horticultural nutrient liquid more homogeneous. The homogeneousness sensor device 306 is configured to determine a homogeneousness of the horticultural nutrient liquid in the loop. The homogeneousness sensor device 306 may include one or more of an electrical conductivity (EC) sensor, a pH sensor, a flowmeter, a level sensor, and a pressure sensor. Data from the sensor device 306 is transferred to the control unit. The control unit processes the sensor data to determine whether the horticultural nutrient liquid in the loop has reached a desired level of homogeneousness. In a non-limiting example, the homogeneousness sensor device 306 includes an EC sensor and a pH sensor, which collect data at a predetermined frequency and transit the data to the control unit. Once the control unit determines that pH and EC have stabilized for a preset period of time, the control unit deems the horticultural nutrient liquid in the loop to be homogenized.

The valve assembly 110 connects the return pipe 302 to the second piping apparatus 128. The control unit 112 is configured for operating the valve assembly 110 to deliver the horticultural nutrient liquid from the return pipe 302 to the one or more pipes 132 of the second piping apparatus 128 when the sensor data indicates that the homogeneousness of the horticultural nutrient liquid is at a desired level. It should be noted that the mixing pump 304, which causes the looping flow of the horticultural nutrient liquid when the valves of the valve assembly are closed, also causes the horticultural nutrient liquid to flow to the pipes 132 of the second piping apparatus 128 when at least one of the valves of valve assembly is open. A flowmeter (which may or may not be part of the homogeneousness sensor device 306) in the mixing apparatus measures the volume of horticultural nutrient liquid that flows out of the mixing apparatus into the pipes 132 for delivery to the plants. Data indicative of the volume flowing into the pipes 132 to the plants can be used to ensure that the plants receive a desired amount of horticultural nutrient liquid. The mixing assembly may include a recirculation valve 305 which controls access from the return pipe 302 to the mixing tank 300.

The mixing assembly may also include an inline filter 350 along the return pipe 302. The inline filter 350 is configured to remove any sediments from the fertilizers in the horticultural nutrient liquid to help ensure that the irrigation emitters don't get clogged. The return pipe 302 may include an access port for the removal and replacement of the inline filter 350.

In some embodiments of the present invention, the fertigation system 100 includes a cleaning agent reservoir 402, which is associated with one of the dosage pumps 122, so that the dosage pump can pump cleaning agent from the cleaning agent reservoir 402 to the piping apparatus 104 and the mixing assembly 108. This cleaning agent is introduced when the mixing assembly 108 has been used to feed one or more plants, and needs to be cleaned at the end of a feeding cycle or before a new batch of a horticultural nutrient liquid is to be introduced into mixing assembly.

In some embodiments of the present invention a “Clean-in-place” (CIP) device 404 located inside the mixing tank 300 is present to spray the walls of the mixing tank 300. The CIP device 404 has a spray nozzle which sprays the cleaning agent on interior sides of the mixing tank between new fertilizer batches to eliminate cross contamination and undesired debris buildup. A valve 307 may be provided to open and close the channel 303 leading to the CIP device 404 from the return pipe 302. The valve 307 may be part of the valve assembly 110.

The control unit is configured to operate the pump 122 associated with the cleaning agent reservoir 402, to introduce the cleaning agent through the into the piping apparatus 104 for entry into the mixing assembly 106. The mixing pump 304 drives the cleaning agent along in the return pipe, into the mixing tank 300 (through the CIP device and/or through return pipe), out of the mixing tank 300 via the return pipe 302, onto one or more a second pipe via the valve assembly, and out of the drain opening of the second pipe to remove fertilizers from the system and prevent clogging of the first and second pipes (or irrigation emitters & lines). The cleaning agent removes fertilizers from the mixing apparatus 108, to prevent fertilizers from an earlier batch to mix with the horticultural nutrient liquid produced in a subsequent batch. In this manner, the ingredients of each horticultural nutrient liquid produced in each batch is known to a high degree of accuracy.

In some embodiments of the present invention, the cleaning agent may include a solution of water with hydrogen peroxide or hypochlorous acid.

As seen in FIGS. 6-10, the mixing assembly 108 may also include an acid pump 312 (e.g., a peristaltic pump) configured to deliver acid from an acid reservoir 308 into the mixing tank 300 or into the return pipe 302, and a base pump 314 (e.g., a peristaltic pump) configured to deliver a base from a base reservoir 310 into the mixing tank 300 or into the return pipe 302. The acid reservoir 308 and a base reservoir 310 may be placed into receptacles 309 and 311. The acid reservoir 308 and a base reservoir 310 may be part of the mixing assembly, or may be associated with and joinable to the acid pump and to the base pump, respectively. The mixing assembly may include a pH sensor 316 (see FIG. 1) (which may be part of homogeneousness sensor) configured to measure a pH of the horticultural nutrient liquid in the mixing tank 300 or in the return pipe 302. The control unit is configured to control the acid pump 312 and the base pump 314 to bring the pH level of the horticultural nutrient liquid in the mixing assembly to a desired level. It should be noted that delivery of the acid or base occurs after all the fertilizers have been injected into the water stream. The pH is monitored as the acid or base is delivered, in order to closely track the pH. This is because the acid and base buffers are available for sale but have varying concentrations of acid and base (generally between 10% and 30%). Therefore, there is no way of knowing the proportion of an acid or base buffer to introduce into a given quantity of horticultural nutrient liquid for achieving a desired pH. Thus, some acid or base is introduced in the mixing apparatus in an iterative process (in which certain quantities of acid or base are introduced and mixed before the pH is measured, and then subsequent quantities of acid or base are introduced or not, depending on the pH measurements) in order achieve the desired pH. The quantities of the portions of acid or base introduced iteratively may be predetermined, or determined dynamically by the control unit.

The control unit is configured for operating the valve assembly 110 to deliver the horticultural nutrient liquid from the return pipe to the second piping apparatus when the pH sensor 316 (see FIG. 1) indicates that that the pH of the horticultural nutrient liquid is at the desired level. In some embodiments of the present invention, one or two front-facing doors 316 and 318 provide access to the components of the mixing assembly.

In FIG. 8, the entry valve 126 is opened, to allow the passage of water the horticultural nutrient liquid from the first piping 104 into the mixing assembly 108-for example into the return pipe 302. In other embodiments of the present invention, the entry valve 126 allows the passage of water the horticultural nutrient liquid from the first piping 104 into the mixing tank. As long as the water in the mixing assembly has not reached a desired level/quantity (for example as measured by a level sensor of the mixing tank 300 or a flow sensor), the entry valve 126 remains open and the valves of the valve assembly 100 remain closed. The horticultural nutrient liquid in the mixing assembly 108 keeps moving in a loop, driven by the mixing pump 304. In some embodiments of the present invention, the return valve 305 (if present) is opened to enable access of the horticultural nutrient liquid from the return pipe 302 into the mixing tank 300.

In FIG. 9, the desired quantity of horticultural nutrient liquid has been reached. The entry valve 126 valve is closed, the return valve (if present) 305 remains opened, and the mixing pump 304 drives the horticultural nutrient liquid in the mixing assembly 108 around the loop to mix the horticultural nutrient liquid. The pH sensor (which may be part of the homogeneousness 306 or may be a separate sensor 316) measures the pH of the horticultural nutrient liquid in the mixing assembly 108. If the measured pH differs from the desired pH, the acid pump 312 or the base pump 314 is activated to inject acid or base into the mixing tank 300 (directly, or via the return pipe 302), depending on whether the desired pH is to be higher or lower than the measured pH.

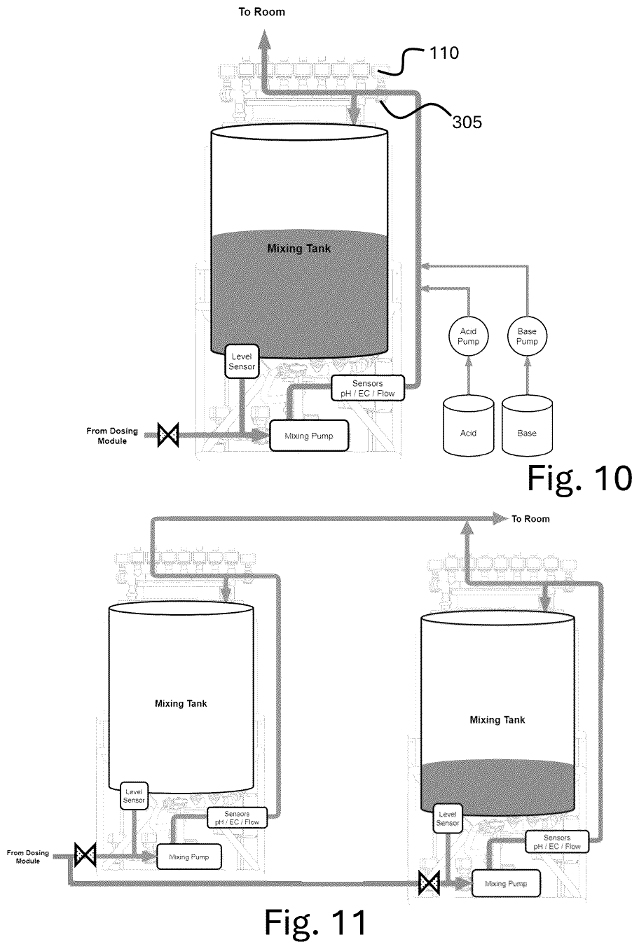

In FIG. 10, measurements from the homogeneousness sensor 306 indicate that the horticultural nutrient liquid has reached a desired level of homogeneousness, while measurements from the pH sensor (which may be part of the homogeneousness sensor 306 or may be a separate sensor 316) indicate that the horticultural nutrient liquid has reached a desired level of homogeneousness. If the right time has come for feeding a plant for which the horticultural nutrient liquid was prepared, the return valve 305 (if present) is closed, while the appropriate valve of the valve apparatus 110 is opened,. In this manner, the horticultural nutrient liquid is driven into a pipe 132 of the second piping 128 toward a desired region to reach the plant for which the horticultural nutrient liquid was prepared.

Referring now to FIG. 11, in some embodiments of the present invention the system includes a plurality of mixing assemblies 108 in series. Each mixing assembly has its respective entry valve 126. The first piping opens at the plurality of mixing assemblies. The entry valves 126 control entry of the horticultural nutrient liquid into the plurality of mixing assemblies. The control unit is configured to control the entry valves 126 to direct the horticultural nutrient liquid to one or more of the plurality of mixing assemblies. This feature allows the system to bypass a mixing assembly that may be not functional or in need of maintenance. In the example of FIG. 11, the leftmost mixing assembly is bypassed, as its entry valve is closed, while the rightmost mixing assembly is filled.

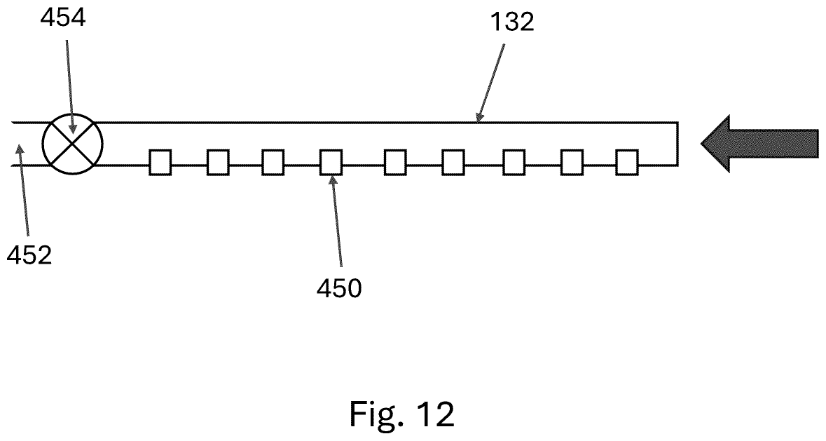

FIG. 12 illustrates an example of a second pipe 132 joined to the fertigation system of FIG. 1, according to some embodiments of the present invention. In some embodiments of the present invention the second pipe is part of the fertigation unit.

The second pipe 132 comprises a plurality of emitter 400 disposed along the length of the second pipe 132. The emitters allow the horticultural nutrient liquid (or, for the matter, any other liquid) to exit therethrough when the liquid's pressure inside the second pipe 132 is higher than a predetermined pressure. The second pipe may have a drain opening 402 downstream of the emitters 400, and a drain valve 404 to regulate access to the drain opening. The drain valve 404 may be controlled by the control unit of the fertigation system.

Delivery of the horticultural nutrient liquid to the plants occurs via the emitters 450 with the drain valve 454 closed, the allow the build-up of pressure in the second pipe 132. After the last scheduled feeding of a predetermined feeding schedule, the drain valve 454 is opened. The remaining horticultural nutrient liquid, if any is left, is disposed of via the drain opening 452, and is pumped at a lower rate by the mixing pump, so the pressure inside the second pipe 132 does not reach the pressure required for emission via the emitters (cracking pressure). The pressure at which the mixing pump pumps the liquid may controlled by the control unit, optionally via a Variable Frequency Drive (VFD). Besides drawing the remainder of the horticultural nutrient liquid, a cleaning agent which cleans the system, as described above, is also driven through the system by the mixing pump at a pressure lower than the cracking pressure of the emitters, and is drained via the drain valve 454. If this were not to be done, horticultural nutrient liquid would been trapped in the irrigation lines for an extended period, which causes scaling inside the pipes, which breaks free and clogs the emitters

As mentioned above, in some embodiments of the present invention, after the horticultural nutrient liquid has been delivered, a cleaning agent is pumped through the fertigation system to remove fertilizers from the first piping and the second piping. The pumps in the system are controlled to deliver the cleaning agent to second pipe 132 at a pressure that is below the pressure required for emission via the emitters while the drain valve is open, so the cleaning agent exits the second pipe via drain opening 402 and not via the emitters 400. The control unit may control the operation of the drain valve 404.

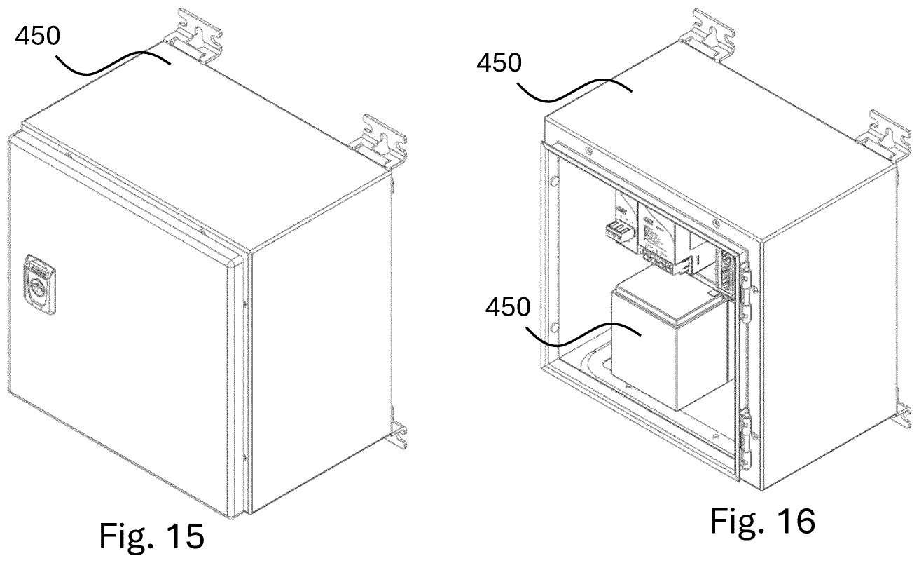

FIGS. 15 and 16 illustrate an example of a control unit 112 of the fertigation system of some embodiments of the present invention, housed in an IP-rated enclosure 450 which is wall-mountable for ease of access.

The control unit 112 may physically linked to all other modules in the system via ethernet cables or via wireless communication. This allows each module to be installed in separate areas of a facility.

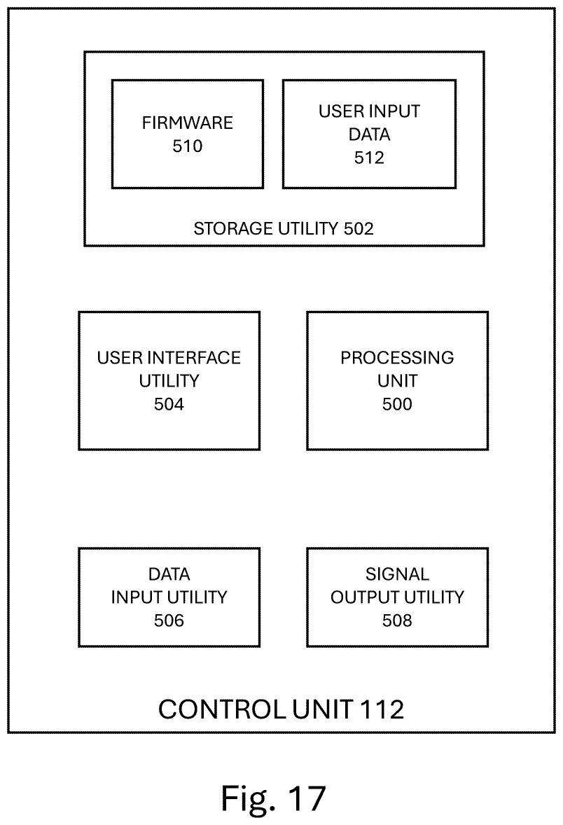

FIG. 17 is a block diagram of the control unit 112, according to some embodiments of the present invention.

The control unit 112 includes a processing unit 500, a storage utility 502, a user interface utility 504, a data input utility 506, and a signal output utility 508. A “utility” is a device which may have software and/or hardware components.

The storage utility 502 is a non-volatile memory utility which stores firmware 510 and user input data 512 for use by the processing unit 500. The user interface utility 504 is configured for receiving user instructions from a user and to store those instructions as the user input data 512 in the storage utility 502. The user input data may include, for example, the desired quantity, pH, composition of a horticultural nutrient liquid, a database of fertilizers, a desires schedule for the creation and delivery of the horticultural nutrient liquid, the name of the user entering the instructions, etc. The user interface utility 504 may also generate for display to a user (for example via connection to a monitor or to a phone via an appropriate graphical user interface (GUI)) a list of tasks to be completed, a status of each task, a status of different elements of the fertigation system, characteristics of the one or more horticultural nutrient liquids, recipes for one or more horticultural nutrient liquids, etc.

The data input utility 506 receives data from the different elements of the fertigation system (e.g. data from the sensors relating to the characteristics of the horticultural nutrient liquid, data from the valves and pumps indicative of operation parameters thereof, etc.). The signal output utility 508 is designed to send to different elements of the fertigation system (e.g., pumps and valves) control signals for controlling the operation of such elements. In some embodiments of the present invention, the data input utility 506 also receives data from the valves 126, 130, 401, and 307, relating to the positions of the valves. This enables the control unit 112 to monitor the positions of the valves and to detect malfunctions of the valves. The control unit is configured to report valve malfunctions. This can prevent valve malfunctions to cause overfeeding or underfeeding of crops.

The processing unit 500 includes one or more processors and may also include a volatile memory utility (such as Random Access Memory, or RAM) that quickly feeds data into the processor(s) for fast processing. The processing unit 500 receives firmware and user input data from the storage utility 502, and receives data from the different elements of the fertigation system, and processes the received data to generate instructions for the different elements of the fertigation system. The instructions are converted into control signals and sent to the respective elements via the signal output utility 508.

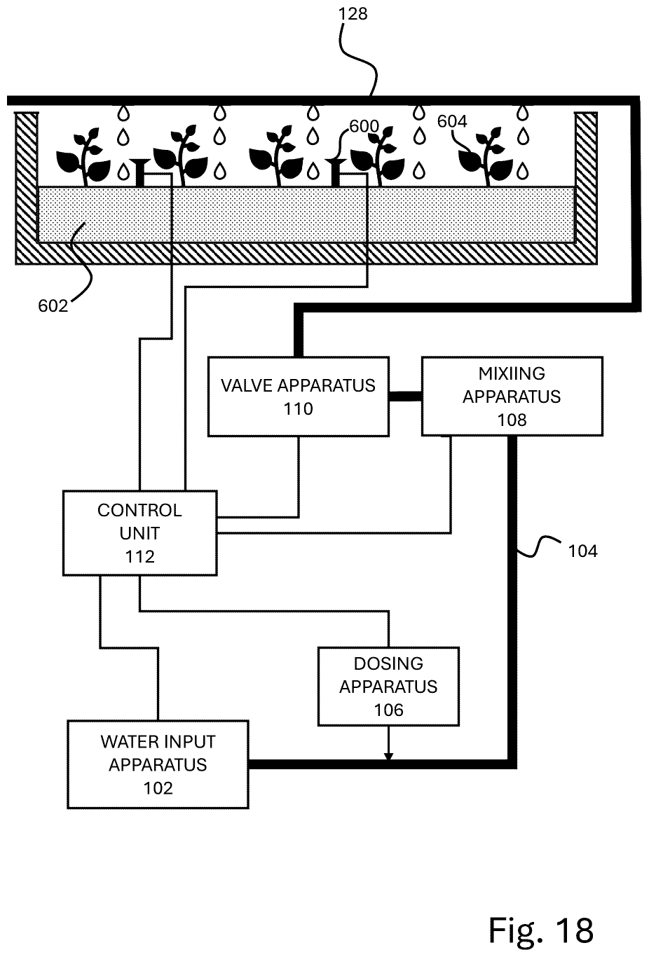

FIG. 18 illustrates a fertigation system which is configured to receive data indicative of characteristics of the medium in which plants grow, according to some embodiments of the present invention.

In some embodiments of the present invention the fertigation system of the present invention receives data indicative of soil characteristics from one or more medium sensors 600 which measure one or more characteristics of the medium 602 in which the plants 604 grow. The medium may be soil or a hydroponic solution. The characteristics of the medium may include one or more of: pH, electrical conductivity, soil moisture content (%), Mineral content (Ca, Mg, N, P, K), for example.

Medium data collected by the medium sensors 600 is received by the data input utility of the control unit 112. The control unit 112 may generate a representation of measurements of the one or more characteristic over time for display to the user, so the user may see the reaction of the medium to fertigation of different horticultural nutrient liquids, which will allow the user to adjust the doses of the different fertilizers and/or the pH of the horticultural nutrient liquids in future feedings. In some embodiments of the present invention, the processing unit of the control unit 112 is configured to process medium data collected in real-time or near real-time, and to change characteristics of the horticultural nutrient liquid (by changing quantities of fertilizers and/or by changing the pH) or to generate a new horticultural nutrient liquid from scratch to match the needs of the plants, which require the medium to have certain desired characteristics. This may be done automatically and without any user input, either according to predetermined algorithms or via machine-learning techniques. In the machine learning techniques, a machine learning system can be trained via training data that includes compositions of horticultural nutrient liquids and the effect of those horticultural nutrient liquids on soils. The machine learning system can find correlations between the input horticultural nutrient liquids and the effects of the input horticultural nutrient liquids on the medium. These correlations can be used by the control unit to modify predetermined recipes of horticultural nutrient liquids or to generate new recipes from scratch, to affect the medium in a desired manner. The processing unit may display the details of the automatically-generated or automatically-modified recipe of horticultural nutrient liquid before manufacturing the horticultural nutrient liquid, for approval by the user.

For example, if the acidity of the medium is outside of a desired range for the growth of a crop a user or the control unit can adjust the recipe to have a higher or lower pH than the original recipe, in order to return the acidity of the medium back to the desired range. In another example, the quantity of a certain mineral (for example, magnesium) in the medium may be higher than desired for a certain crop. The user or the control unit may adjust an original recipe which contained magnesium not to contain any magnesium for future feedings, until the quantity of magnesium in the medium has returned to be with a desired range. In another example, the quantity of a certain mineral (for example, magnesium) in the medium may be lower than desired for a certain crop. The user or the control unit may adjust an original recipe which contained magnesium to contain higher levels of magnesium for future feedings, until the quantity of magnesium in the medium has returned to being with a desired range.

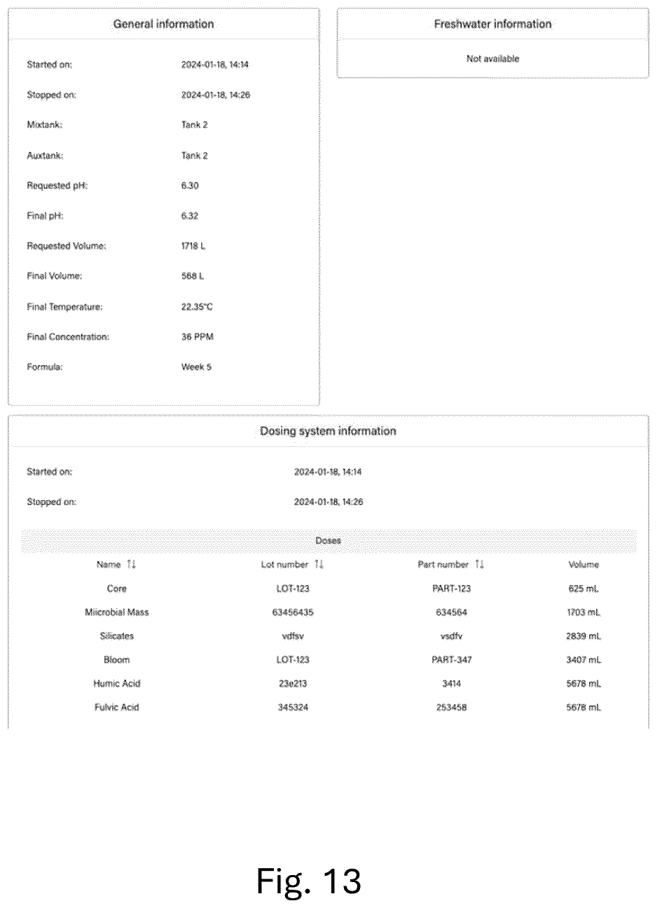

FIG. 13 is a screenshot generated by the user interface utility of a control unit of the present invention, showing “Batch-record” which includes serial numbers and quantities of all chemicals used to create a certain horticultural nutrient liquid, the pH, electric conductivity (EC), and temperature of the horticultural nutrient liquid, and the name of the user who instructed the system of the present invention to generate the horticultural nutrient liquid.

The control unit may be accessible via a user interface for controlling the operation of the system of the present invention. With the control unit, the user is able to create and save a plurality of the horticultural nutrient liquid recipes (for example recipes with up to 12 ingredients). The fertigation system of the present invention is able dispense different horticultural nutrient liquid in various sequences to eliminate the risk of chemical reactions between different horticultural nutrient liquids. This is done by controlling the operation of the system automatically via the control unit.

Since all of the consumables (fertilizers, and optionally acid and base, as well) in a horticultural nutrient liquid are tracked, the control unit has a unique software feature that allows the user to input the serial numbers of all of the consumables connected to the system. When a recipe of a horticultural nutrient liquid is created a “Batch-record” is generated which includes the serial numbers of all chemicals used, the pH, electrical conductivity and temperature, as well as who called for the fertilizer solution, and the group of plants the horticultural nutrient liquid is delivered to. In this manner, the fertigation system creates accountability and quality control. An example of a batch record can be seen in FIG. 13.

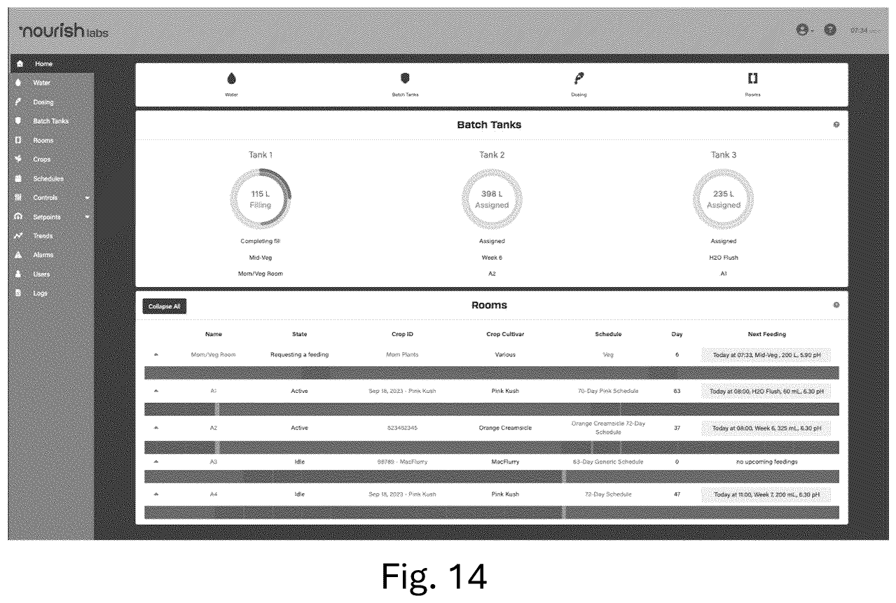

FIG. 14 is a screenshot generated by a control utility of the present invention, showing an interactive home screen dashboard that provides information about an activity of the fertigation system within a predetermined or chosen time period.

In some embodiments of the present invention, the control unit generates an interactive home screen dashboard that the user can look at and get an instant insight into what's taken place in the cultivation facility within a predetermined or chosen time period (or example, during the past 24 hours) by looking at the state timeline diagram shown in FIG. 14.

In the example of FIG. 14, each line corresponds to a certain crop in the cultivation facility. In each line, a purple segment indicates a time period (called “active”) in which the crop is being fed according to a active feeding schedule. A blue segment indicates a time period (called “nighttime”) during which the crop is not being fed. Each green segment indicates a feeding event (called “requesting a feeding”) in which a horticultural nutrient liquid is being prepared. Some of the nighttime periods may start with a feeding event, in which a horticultural nutrient liquid (generally only water) is prepared to keep the plant alive until the first feeding of the next day. In some cases, there may be additional feedings throughout the nighttime period if the crop is experiencing aggressive growth. Without these feedings, the crops would wilt or perish.

The control unit may have a unique scheduler utility accessible and programmable via the user interface utility. The scheduler utility allows the user to adjust the recipes and pH throughout the day. The scheduler utility gives the user the ability to enter the number of plants in a grow area. It's this scheduler utility, in combination with the mixing assemblies which have independent pH-control, that allows the fertigation system of the present of the present invention to make adjustments throughout the day to provide the most control of the electric conductivity and pH of the plant substrate. Custom schedules can be created for nearly any type of crop (e.g., Strawberries, tomatoes, peppers, cannabis). The user is able to make micro-adjustments to each cultivar schedule & recipe independently, therefore optimizing the crops but also giving the cultivator the ability to gain more consistency over different crops of the same type.

In a non-limiting example, the control unit allows for one or more dosing panels to feed up to eight mixing tanks.

As noted above, the fertilizers are dispensed into a mixing apparatus and then the pH is balanced in the mixing apparatus. After water and fertilizer(s) are dispensed into the mixing apparatus, then a closed-loop circulation process is initiated. Once the closed loop is initiated either acid or base is dispensed.

The system of the present invention allows preparation of a horticultural nutrient liquid in a unique way. This process requires both unique software and hardware equipment. Each horticultural nutrient liquid is prepared fresh for the crops every single time ensuring the most pH-accurate and oxygen-rich horticultural nutrient liquid possible. In order to do this, the system of the present invention prepares the exact volume that the plants need, when they need it, thus eliminating the need for “Day-Storage Tanks” which are prone to pH-drift, fertilizer sediment (mineral precipitate from solution), biological growth, and lowered Dissolved Oxygen (DO) due to settling and warming of the solution (as warmer solutions are able to retain less dissolved oxygen).

In some embodiments of the present invention, the system of the present invention uses a mathematical approach to produce a horticultural nutrient liquid.

The freshwater water input apparatus provides the mixing tanks with the amount of water required to prepare a fertilizer solution. The volume of water required is calculated as (A):
500 plants (x) need to be watered. Each plant has 2 emitters (z) that flow @4000 ml/hour (y).
A total of 200 ml (w) of horticultural nutrient liquid must be dispensed to each plant as per schedule.
500×200=100,000 Ml or 100 L (a) Total Volume Required.
2×4000=8000 ml/Hour (B) Total Emitter Flowrate per Plant per Hour.
8000/60=133.33 Ml/Minute (c) Total Emitter Flowrate Per Plant per Minute.
133.33/60=2.22 ml/Second (D) Total Emitter Flowrate per Plant per Second.
200/2.22=90.09 Seconds of horticultural nutrient liquid must be dispensed to meet the needs of 200 ml per plant. (E)

Expressed as:
A=xy
B=zy
C=B/60
D=C/60
E=w/D

### EXAMPLE

A total of 100 L (A) of horticultural nutrient liquid is required. It should be noted that the volume of the pipes leading to the crop being fed is also considered as part of the initial setup of the system. This volume is added to the quantity (A) of the recipe to ensure that there is exactly enough requested horticultural nutrient liquid to reach every single plant in a group. Fertilizer “F” has been saved in the fertilizer formula at 20 ml/L (W). The total amount of (F) required is (G):
(A)×(W)=(G)
100×20=2000 ml of Fertilizer (F) is required for the solution in this example.

The above calculation would be conducted for every fertilizer ingredient of a complete horticultural nutrient liquid. The sequencing of each fertilizer can also be controlled to reduce the risk of chemical reactions between each fertilizer ingredient. After all these calculations are made by the control unit, the control unit control the water input apparatus to input the desired amount of water and the dosing apparatus to input the desired amounts of fertilizers. Once the horticultural nutrient liquid is mixed, homogenized, and pH balanced, the valve apparatus is controlled by the control unit to enable passage of the horticultural nutrient liquid to the second piping apparatus and the mixing pump is controlled to supply the horticultural nutrient liquid to the desired plants for the time period (E).

Thus, in some embodiments of the present invention, each fertilizer is dispensed based on total volume required for a solution (not proportionately, like the general art) into a stream of water for a certain amount of time, which depends on the dispensing speed of the fertilizer pump associated with the fertilizer. When a fertilizer is dispensed inline “proportionately” (as known in the general art), the solution doesn't get a chance to fully mix and homogenize before arriving at the plant's substrate. When a fertilizer is dispensed based on total volume required (exact ml/plant) there is a higher resolution of accuracy rather than time-based dispensing. When dispensing proportionately, it is also critical that the means of dispensing fertilizers into a stream (usually through a venturi-style system) be calibrated more frequently to ensure the proportions are correct. Since all fertilizers required are being dispensed at the same time in the general art, there is a risk of chemical reactions between concentrated fertilizers being used.

In contrast with the general art, the system of the present invention is able to dispense each fertilizer based on total volume required for a solution. Therefore, the system of the present invention can set delays between fertilizers being added to alleviate the risk of chemical reactions. For example, a silicate may be fully dissolved into the mix tank before the subsequent dispensing of the remaining fertilizers. The system of the present invention therefore provides a lot more flexibility with batch preparation over inline dosing, and requires less precision in the delivery of fertilizers while achieving a higher accuracy in the preparation of a desired horticultural nutrient liquid.

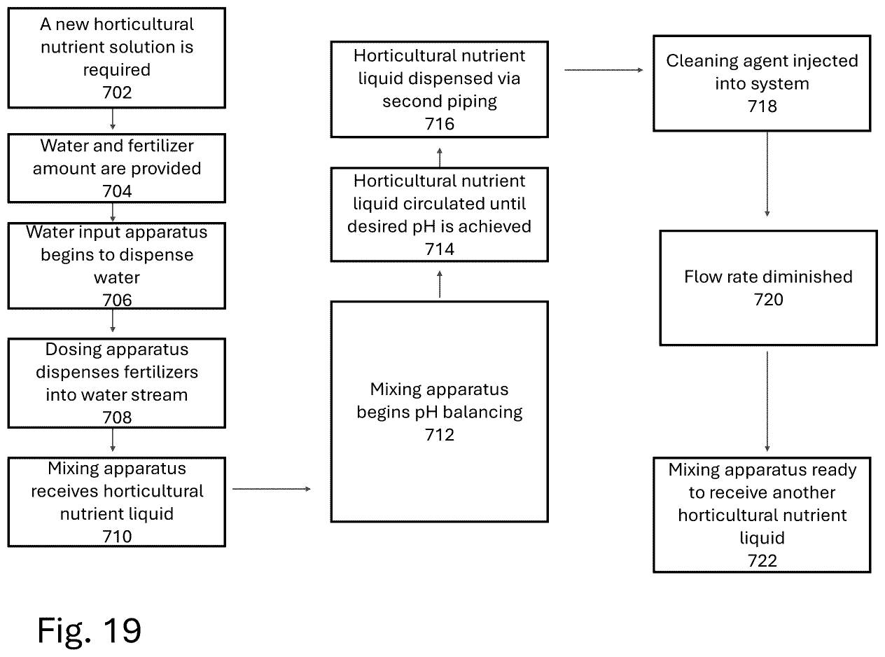

FIG. 19 illustrates a flowchart 700 showing an example of a how the system of the present invention creates and dispenses a horticultural nutrient liquid.

At 702, a new horticultural nutrient liquid is requested. This may occur when a user enters a certain formulation for the horticultural nutrient liquid, or according to a schedule previously set by a user. The characteristics of the horticultural nutrient liquid to be created may be modified from an original user's request according to characteristics of the soil measured in real time or near-real time.

At 704, the water and fertilizer amounts for the formulation of the new horticultural nutrient liquid are provided. The water and fertilizer amounts may be provided directly by a user via the user interface utility of the control unit, or a recipe and required amount of a previously used horticultural nutrient liquid may be selected by the user, while the processing unit of the control unit calculates the required water and fertilizer amount for the desired quantity.

At 706, the water input apparatus begins to pump water into the first piping. At 708, the dosing apparatus dispenses the required fertilizer(s) into the water stream in the first piping. In some embodiments of the present invention, the fertilizers are dispensed based on the total amount of horticultural nutrient required, as explain above. At 710, the mixing apparatus receives the horticultural nutrient liquid.

At 712, pH balancing starts in the mixing apparatus, and an acid or base is injected into the horticultural nutrient liquid to create a pH-balanced horticultural nutrient liquid. At 714, the pH-balanced horticultural nutrient liquid is circulated in the closed loops of the mixing apparatus until the desired pH is stable and the pH-balanced horticultural nutrient liquid is homogeneous.

At 716, the pH-balanced horticultural nutrient liquid is dispensed to the plants over a predetermined time period via the second piping.

In some embodiments of the present invention, at 718, after the pH-balanced horticultural nutrient liquid has been fully dispensed to the plants, a cleaning agent is injected into the system to clean the system. The cleaning agent may be mixed with water.

At 720, the flow rate is diminished by controlling the mixing pump, in order to decrease the pressure inside the second piping, and the drain valve is opened. So, the cleaning agent and remaining pH-balanced horticultural nutrient liquid exit from the drain exit without contaminating the medium in which the plants grow. At 722, the cleaning ends and the mixing apparatus is ready to receive another horticultural nutrient liquid.

Some advantages of the present invention include:

### 1. Modular Design of the Fertigation Platform:

The fertigation system is comprised of two main stock keeping units (SKU's): the dosing apparatus and a mixing apparatus. Fresh water enters the dosing apparatus where fertilizers are injected via (peristaltic) dosing pumps. Each dosing pump can be a different liquid fertilizer, or more than one dosing pump can be placed into a single fertilizer container to increase dispensing rate and add redundancy. After the fertilizer water leaves the dosing apparatus, it travels to a mixing apparatus and enters the mixing apparatus through a valve that opens. If there is more than one mixing apparatus, the fertilizer/water solution is distributed to one or more desired mixing apparatuses. If internal mechanical components of a mixing apparatus fail, a signal is sent from the components of the mixing apparatus to the control unit, to instruct the control unit to queue up another mixing apparatus for mixing and pH balancing of a horticultural nutrient liquid.

A single dosing apparatus can support a plurality of mixing apparatuses disposed in series or in parallel. A plurality of dosing apparatuses may be provided.

Each mixing apparatus independently pH-balances the horticultural nutrient liquid.

Redundancy is created by having a plurality of mixing apparatuses, so that if one mixing apparatus breaks, the system can still operate properly.

Communication between the control unit and the elements of the system that are controlled by the control unit may be wired and/or wireless. In some embodiments of the present invention, ethernet cables are used to provide wired communication.

### 2. Automated Batch Preparation of Fertilizer Solutions:

The system of the present invention features a closed-loop process line assembly with inline sensors and acid & base injection ports. When the horticultural nutrient liquid enters the mixing apparatus from the dosing panel, the horticultural nutrient liquid begins to circulate within the mixing apparatus. The control unit monitors the pH and EC level horticultural nutrient liquid to determine how much acid or base needs to be added to the horticultural nutrient liquid to achieve the desired pH level. Once the pH level is achieved and has stabilized for a set period of time, the pH-balanced horticultural nutrient liquid exits the system via the valve apparatus and begins to enter the irrigation lines.

Precise, consistent, homogenous horticultural nutrient liquid are created.

The horticultural nutrient liquid is pH-stable before being sent out to the crops.

All plants are certain to receive equal levels of fertilizers and the same pH throughout the entire group of plants being watered.

Even the smallest irrigation events will deliver the exact pH that the cultivator has called for.

Enhanced levels of dissolved oxygen by production of a desired amount of an horticultural nutrient liquid and quick provision of the horticultural nutrient liquid to the plants.

The mixing tank and return pipe provide a mechanical-less agitation of the horticultural nutrient liquid for achieving homogeneousness.

The closed-loop circulation of the horticultural nutrient liquid is constantly monitored with sensors.

Each mixing apparatus can independently control the pH of the horticultural nutrient liquid inside of it. Each mixing apparatus can produce completely different horticultural nutrient liquid at a respective pH, regardless of the water's pH and mineral composition of the water (which affects the pH of the water). This is important because a pH and mineral composition of the water may vary (often times seasonally, affected due to glacial runoff). The automatic measurements and pH balancing capability provided by the present invention enables accurate production of a desired horticultural nutrient liquid regardless of the properties of the input water.

Each mixing apparatus operates independently and dispenses fertilizer solutions with its own dedicated mixing pump. Each mixing apparatus is able to be plumbed so that it can feed other zones which other mixing apparatuses are connected to (for redundancy). This also allows for an increasingly higher liquid volume throughput (modularity) based on a growing cultivation facilities footprint.

### 3. Batch-Records and Consumables Tracking:

Autogenerated batch records contain the serial numbers of every single fertilizer ingredient being used in the horticultural nutrient liquid.

Batch records include the pH and EC, time and date, and volume of the horticultural nutrient liquid being created.

### 4. Form Factor:

In some embodiments of the present invention, a 30, 150, 325, 1000-gallon cone-bottom mixing tank is affixed to a custom-made steel tank stand that has a stainless-steel skirting wrapped around the bottom of the cabinet which houses the electronics, pumps and sensors.

The doors of the cabinet double as storage for the pH balancing mechanicals and the controls unit.

A rack above the mixing tank supports the valves of the valve apparatus

What is claimed is:

1. A system for preparation and delivery of a horticultural nutrient liquid, the system comprising:
a first piping apparatus, configured to receive water from a water source;
a dosing apparatus comprising a plurality of dosage pumps which are configured to draw respective fertilizers from a plurality of fertilizer containers and to inject the respective fertilizers into the first piping apparatus, to generate a horticultural nutrient liquid;
a mixing assembly, configured to receive the horticultural nutrient liquid exiting from the first piping apparatus after the water has been injected with one or more of the fertilizers, the mixing assembly being configured to mix the horticultural nutrient liquid;
a valve assembly configured to control passage of the horticultural nutrient liquid from the mixing assembly to a second piping apparatus configured to deliver the horticultural nutrient liquid from the mixing assembly to one or more plants.

2-16. (canceled)

17. The system of claim 1, wherein the mixing assembly being configured to mix the horticultural nutrient liquid, so that the horticultural nutrient liquid is homogeneous.

18. The system of claim 1, further comprising a control unit configured to control operations of the dosing apparatus, the mixing assembly tank, and the valve assembly.

19. The system of claim 18, wherein:
the mixing assembly is configured to mix the horticultural nutrient liquid so that the horticultural nutrient liquid is homogeneous, and comprises:
a mixing tank;
a return pipe exiting the mixing tank and returning into the mixing tank;
a mixing pump configured to draw the horticultural nutrient liquid from the mixing tank into the return pipe;
a sensor configured to measure one or more parameters indicative of a homogeneousness of the horticultural nutrient liquid exiting the mixing tank and output sensor data; and
wherein the valve assembly connects the return pipe to the second piping apparatus;
the control unit is configured to process the sensor data to determine a level of the homogeneousness of the horticultural nutrient liquid.

20. The system of claim 19, wherein:
the mixing assembly comprises an acid pump and a base pump, the acid pump being configured to deliver acid from an acid reservoir into the mixing tank or the return pipe, and the base pump configured to deliver base from a base reservoir into the mixing tank or the return pipe;
the mixing assembly comprises a pH sensor configured to measure a pH of the horticultural nutrient liquid in the mixing tank or the return pipe;
the control unit is configured to control the acid pump and the base pump to bring the pH level of the horticultural nutrient liquid in the mixing assembly to a desired level.

21. The system of claim 18, comprising a plurality of mixing assemblies, wherein:
the first piping comprises a single first pipe opens at the plurality of mixing assemblies;
the system comprises a plurality of entry valves controlling entry of the horticultural nutrient liquid into the plurality of mixing assemblies;
the control unit is configured to control the entry valves to direct the horticultural nutrient liquid to one or more of the plurality of mixing assemblies.

22. The system of claim 18, comprising the second piping, wherein the second piping comprises:
at least one pipe having a plurality of emitters along a length of the pipe and a drain opening downstream of the emitters;
a drain valve configured to open and close the drain opening;
wherein the control unit is configured to selectively open the drain valve to enable dumping of the horticultural nutrient liquid inside the second piping out of the drain opening.

23. The system of claim 18 comprising a water input apparatus configured to draw water from the water source into the first piping, wherein the control unit is configured to:
receive input data comprising a number of plants in a grow area and an amount of the horticultural nutrient liquid each plant requires;
process the input data to calculate a total volume of the horticultural nutrient liquid required for the grow area and a time period during which the total volume of horticultural nutrient liquid is dispensed to the grow area;
receive data indicative of a recipe of the horticultural nutrient liquid, wherein the data indicative of the recipe comprises a proportion of each of the fertilizers in the horticultural nutrient liquid;
process the total volume of the horticultural nutrient liquid and the data indicative of a recipe of the horticultural nutrient liquid, to calculate a total amount of each of the fertilizers to inject into the water;
process the total volume of the horticultural nutrient and total amount of each of the fertilizers to calculated a desired amount of water;
control the water input apparatus to draw the desired amount of water and control the dosing unit to inject the total amount of each of the fertilizers, to form the horticultural nutrient according to the recipe.

24. The system of claim 23, wherein the control unit is configured to control the dosing apparatus to set a delay between the injection of each fertilizer.

25. The system of claim 1, wherein at least one of the dosing pumps the dosing apparatus is connectable to a cleaning agent reservoir and is configured to inject a cleaning agent into the first piping.

26. The system of claim 19, wherein:
wherein at least one of the dosing pumps the dosing apparatus is connectable to a cleaning agent reservoir and is configured to inject a cleaning agent into the first piping;
the mixing apparatus comprises a spray nozzle configured for receiving the cleaning agent and spraying the cleaning agent on interior sides of the mixing tank.

27. The system of claim 26, comprising a channel leading from the return pipe to the spray channel and a valve configured to be controllably opened and closed for regulating passage of the cleaning agent from the return pipe into the spray nozzle.

28. The system of claim 19, wherein the control unit is configured to control a pressure at which the mixing pump pumps the horticultural nutrient.

29. The system of claim 18, wherein the control unit comprises a user interface utility configured to receive user instructions and a storage utility for storing the user instructions.

30. The system of claim 18, wherein the control unit comprises a user interface utility configured to generate for display an interactive dashboard that provides information about an activity of the fertigation system.

31. The system of claim 18, further comprising at least one medium sensor measure one or more characteristics of a medium in which at least one of the one or more plants grows and to generate medium data, wherein:
the control unit is configured to receive the medium data at a predetermined frequency and provide a representation of measurements of the one or more characteristic over time for display.

32. The system of claim 18, further comprising at least one medium sensor configured measure one or more characteristics of a medium in which at least one of the one or more plants grows and to generate medium data, wherein:
the control unit is configured to receive the medium data at a predetermined frequency and process the medium data to modify a predetermined recipe of horticultural nutrient liquids or generate a new recipe of the horticultural nutrient liquids to match a need of the at least one of the one or more plants based on the medium data.

33. The system of claim 18, comprising a water input apparatus configured to draw water from the water source into the first piping, wherein the control unit is configured to control an operation of the water input apparatus.

34. The system of claim 1, wherein:
the mixing assembly comprises:
a mixing tank;
a return pipe exiting the mixing tank and returning into the mixing tank; and
a mixing pump configured to draw the horticultural nutrient liquid from the mixing tank into the return pipe;
wherein the valve assembly connects the return pipe to the second piping apparatus.

35. The system of claim 1, comprising a plurality of mixing assemblies, wherein:
the first piping comprises a single first pipe opens at the plurality of mixing assemblies; and
the system comprises a plurality of entry valves controlling entry of the horticultural nutrient liquid into the plurality of mixing assemblies.
